(19) United States
(12) Patent Application Publication
(10) Pub. No.: US 2016/0337750 A1
(43) Pub. Date: Nov. 17, 2016

(54) Wearable Acoustical Devices and Acoustic Generation

(71) Applicant: James Louis, Granby, MA (US)

(72) Inventor: James Louis, Granby, MA (US)

(21) Appl. No.: 15/156,296

(22) Filed: May 16, 2016

Related U.S. Application Data
(60) Provisional application No. 62/161,574, filed on May 14, 2015.

(51) Int. Cl. H04R 1/40

(52) U.S. Cl. CPC H04R 1/403; H04R 2400/03

(57) ABSTRACT

Devices for acoustical generation and localization of produced sound are presented, as well as methods for generating sound waves using the devices. The devices are intended to be wearable by a person, and the sound generated is localized to the person's immediate surroundings such that the person wearing the device can hear the sound, but the audio produced is not audible to others. The devices utilize ultrasonic frequencies to generate audible sounds localized to the person wearing the device, meaning audible only to the wearer. In some embodiments, the device and methods use vibrations to generate low frequencies audible to the wearer. In some embodiments, the devices can communicate wireless with mobile computers for one-way or two-way audio transmission, and the devices may communicate with other devices. In other embodiments, the devices may generate anti-sound for cancellation of external sounds.

### FIELD OF THE INVENTION

The presently disclosed subject matter relates to improved devices and methods for acoustical generation, and more specifically, to improved devices and methods for using one or more of ultrasonic frequencies, vibrations, or subsonic frequencies to generate sound that is audible only in a localized region.

### BACKGROUND OF THE INVENTION

The need, and the desire, to listen to audio information is commonplace and widespread. People listen to music throughout the day, for entertainment or for motivation during exercise, among other reasons. People have phone calls and video calls (with an audio component), and need to be able to hear the other person or people speaking, as well as speak and be heard and understood. People listen to podcasts, webcasts, audiobooks, movies, radio dramas, and much more. And people need access to this audio information not just when seated at home or at a workplace, but when they are on the move: walking, out for exercise, at a gym, while on public transportation, and in a variety of other settings.

There are existing options for listening to audio information: headphones that sit on or over the ears with speakers directed towards and/or away from the ears, earbuds that are smaller headphones that fit in peoples' ears, and headphones that sit above or near the ear, and play sounds near or across the opening of the auditory canal of the ears. All of these options exist, and all have shortcomings. First, many of the existing options are bulky, which makes them relatively difficult to transport, relatively heavy, and relatively breakable—and to be less breakable, they are made heavier and bulkier as a general rule. The current art in headphones and other portable speakers do not provide a wearable source of high-quality audio that is comfortable to wear for a day, without being unduly bulky or unfashionable to wear.

Second, most such headphone options communicate by wire with the source of the audio information. Having a wire attached to an object on one's head can be uncomfortable, or distracting, and in some circumstances unsafe if the wire snags on an object and the headphones yank at the wearer's head or ears. To avoid this problem, there are wireless headphones, but the wireless receiver and the battery required to power the wireless receiver, and the speakers, add to the bulk and mass of the headphones. With large headphones, the increase in bulk and mass may be less noticeable, but not all users want large headphones. With earbuds, the increased bulk and mass are impractical for lightweight earbuds. For producing high-quality stereo audio, with the range of human-audible sounds (20 Hz to 20 KHz), a small battery powering a single speaker is inadequate (in contrast to, say, a wire receiver and speaker that is adequate for voice-only communications, e.g. a wireless earbud and microphone for phone calls). The current art do not provide a solution for wireless high-quality stereo sounds without excessive bulk and mass on the wearer's head.

Third, the current art in headphones, earbuds, over-the-ear speaker systems, and other portable wearable devices for sound generation broadcast the sound to everyone in the vicinity. The wearer, as listener, has a stark choice: turn the volume down, so that she or he can barely hear it, so that others nearby cannot hear it. Or, leave the volume up so that the wearer/listener can enjoy the music, or hear the speaker—and so will everyone else nearby. This latter outcome is a poor solution, as many bystanders do not want to hear others' music or other audio, and a wearer/listener will often face social pressure to turn it down or off—or may be in a place where one is prohibited from having audio playing. Sometimes a wearer may not want to have the audio audible to everyone nearby, such as with communications involving sensitive or confidential information.

While there are audio systems that localize sound for stationary listening, such as in-home or in-office settings, the current art does not meet market needs for wearable localized sound that is not audible to bystanders. Some systems that present the ability to localize sound use parabolic speakers: one or more speakers where the speaker driver is directed into a parabolic reflector. While parabolic speakers can reflect sound in a directed beam of plane waves, there are engineering limitations: they are relatively bulky because the lowest frequency that can be controlled in the beam has a wavelength equal to the radius of the speaker. That is, to control a beam that includes sound as low as 20 Hz, roughly the lower limit of human hearing, the parabolic reflector must be roughly 50 feet across. Such a loudspeaker is impractical for even most stadium concerts. For in-home use, the current art allows localized sound with parabolic speakers, and a woofer or subwoofer for lower frequencies. But for the wearable market, it is not feasible to carry or wear a subwoofer.

There are other challenges to using directional sound: that is, sound waves in a beam, which spread less than sound waves produced by a point source—such as typical speakers. In any directional system, the directionality correlates directly with the size of the wave-generating source, in relation to the wavelengths it generates. With a larger wave-generating source relative to the wavelength of the sound waves, the source will generate a beam of sound waves that is more directional. To achieve greater directionality in sound production, it is known in the art to use audible sound frequencies by modulating the audible sound frequencies onto high frequency carrier waves, known as ultrasound because the frequencies are above the range of normal human hearing (above 20 KHz). Modulating, in this context, means using an ultrasound, also known as an ultrasonic, carrier wave, and encoding audio information onto it by varying the instantaneous frequency (or another property) of the ultrasonic carrier wave; the information encoded onto the ultrasonic carrier wave is the audio information that is to be reproduced such that a listener may hear it. Such systems, known as ultrasonic devices, achieve far greater directionality than is possible using only human-audible sound waves, because of the much shorter wavelengths of the ultrasound frequencies. Because the ultrasound frequencies have shorter wavelengths, a speaker of a given size will generate a much more directional beam of sound with ultrasound frequencies than with audible frequencies, and the ultrasound beam will attenuate and spread out much less quickly than the beam made with audible sound. Correspondingly, a directional speaker system using ultrasound frequencies can be made much smaller than a directional speaker system using audible frequencies, and the ultrasound directional speaker system can still achieve the same degree of directionality as the audible-frequency directional speaker system. One limitation of the known art of ultrasound frequency speaker systems that that they are understood to have little if any capability to accurately reproduce and include in the directional sound beam the lower frequencies audible to people. In a stadium setting, or an in-home setting, this is not a terrible limitation, as woofers and subwoofers are available, can be placed in a variety of settings, and have low directionality, such that they will be able to communicate low frequency information or sound to all parts of a room or stadium. But, this presents limitations and problems when the headphone or wearable market is considered: woofers tend to be larger, tend to draw relatively high amounts of power, and have little to no control over directionality of sounds and thus where the sound is and is not audible.

Fourth, headphones or headset solutions in the current art tend to focus on either providing high-quality stereo audio and not have a microphone to be used in communications, or on providing audio that is optimized for listening to voice communications and includes a microphone.

Fifth, most headphones in the current art are not waterproof and so are not suitable for use in day-long outdoor activities.

These constraints on the current art of mobile wearable audio generation have limited the flexibility of people as listeners, whether they are listening to music, phone or video calls, radio, television, or internet broadcasts, including podcasts, or recorded information.

### SUMMARY OF THE INVENTION

The present invention meets all these needs, by disclosing devices for wireless reception and transmission of audio information, generation of high-quality audio reproducing a full or near-full range of sounds audible to people, and for localizing the sounds produced to be audible only in a small region at or near the head or ears of the wearer/listener. The present invention presents methods for generating audio that is localized to a small region, at or near the head or ears of the wearer of a device, from a wearable device, that may be in wireless communication with a source of audio information. At a high level of summary, in the presently disclosed methods, the devices are controlled to generate and transmit one or more of ultrasonic frequencies, vibrations, or subsonic frequencies to generate sound that is audible only in a localized region. At a high level of summary, the presently disclosed devices comprise one or more of a plurality of ultrasonic speakers, a plurality of speakers capable of generating audible sound, which may be combined with the plurality of ultrasonic speakers, a plurality of vibration-generating speakers or haptic generators or devices, or a plurality of subsonic speakers, as well as wireless communication equipment, optionally a plurality of microphones, microprocessors for carrying out processing of information and control of the sound, ultrasound, vibration, and subsound generating components, a plurality of batteries, and an optionally waterproof housing.

An object of the invention is to provide smaller and lighter portable speaker systems, for audio reproduction on or near a person. Another object of the invention is to provide durable and non-fragile speakers systems, that can be worn or carried. In concert, the present invention aims to provide speaker systems that can be worn or carried for long periods, such as an entire day, without discomfort and without feeling like one is carrying or wearing something ugly or unfashionable.

A further object of the present invention is to provide a wireless personal speaker system, with high-quality reproduction of the full range of sound audible to people, and in a package that is not excessively bulky or heavy, and thus is comfortable and fashionable to wear.

Another object of the present invention is to provide a portable personal system for sound localization that allows a user to listen, at a comfortable and user-preferred decibel level, to high-quality audio reproduction with a full range of audible frequencies, while not broadcasting the audio playback to anyone in the user's vicinity. The present invention provides this with a combination of ultrasonic speakers, audible-range speakers, and subsonic or haptic speakers. The combination localizes the audio playback so that it is audible to someone holding, carrying, or wearing the device or devices implementing the presently disclosed invention, and not audible to anyone else nearby. This improves on the prior art, by providing a system to combine ultrasonic sound localization, audible-frequency audio modulating the ultrasonic carrier waves, and low-frequency sounds through vibrations, touch-based information transmission, and/or subsonic speakers, and providing all this in a compact system that can be carried or worn by a user.

A further object of the present invention is to present systems for compact or wearable high-quality audio reproduction of the full range of audible frequencies, and provide a plurality of microphones to enable the present invention to be used for conversations in two-way audio or video communications, while faithfully reproducing the full range of audio information and frequencies in the communication. The presently disclosed invention may also be used for control of voice-operated systems, such as smartphones or other voice-operated smart devices, including any devices in the so-called internet-of-things.

Lastly, an object of the present invention is to provide any or all of the above goals of the present systems or devices, in a form that is waterproof or water-resistant, and thus suitable for use in extended activities or during exercise. Accordingly, an audio-producing system as described herein would be sufficiently water-resistant that neither rain nor sweat would impede the functioning of the devices, or destroy them, so that they could be worn and used during a workout, or outdoors while it is raining.

As a mid-level overview of the present invention, the presently disclosed invention relates to portable devices for individual audio reproduction, localization of sound, and audio pickups for communication and/or control. The present invention provides improvements over headphones, earbuds, and other personal speaker systems, by providing a device or devices that can be worn or carried by a person, and provide high-fidelity audio reproduction of a full range of human-audible frequencies, while localizing the audio playback to be audible only in a certain region or regions. The present invention also provides improvements in personal audio playback by providing such device or devices in a compact and easily transported form, and in some embodiments of the present invention, in a form that is wireless, and/or waterproof or water-resistant, and/or fashionable, such that the device can be worn or carried for an extended period and for a range of activities including exposure to water, and/or during physical exertion. The present invention also provides methods for controlling the device or devices to produce localized high-fidelity audio, reproducing the full range of human-audible frequencies. Accordingly, any such applications of the present invention provide improved convenience, control, and flexibility over the present art.

These aspects of the present invention, and other disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but, the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a perspective view of an exemplary embodiment of a device of the present invention described herein.

FIG. 2 is a top elevation view of an exemplary embodiment of the present invention.

FIG. 3 is bottom elevation view of an exemplary embodiment of the present invention.

FIG. 4 is a side elevation view of an exemplary embodiment of the present invention.

FIG. 5 is a front elevation view of an exemplary embodiment of the present invention.

FIG. 6 is bottom elevation view of an exemplary embodiment of the present invention.

FIG. 7 shows a perspective view of an exemplary embodiment of a sound generation component (which may house speakers, haptic elements, and/or other sound-producing elements), as part of an exemplary device embodying the present invention.

FIG. 8 shows a perspective view of an exemplary embodiment of a control component (which may house one or more of batteries, wireless communications modules, microphones, and/or microprocessors), as part of an exemplary device embodying the present invention.

FIG. 9 depicts a schematic cross-section of an exemplary sound generation component, illustrating an exemplary parabolic speaker, acoustical signals, and acoustical plane waves.

FIG. 10 depicts an exemplary method of processing audio information, comprising one or more of regulating, amplifying, and modulating to generate control signals to be used to drive one or more of the plurality of speaker types or haptic generators which may be used in some embodiments of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The present subject matter discloses devices for localized acoustical generation, and methods of operating such devices to generate localized acoustical information, i.e. sound that is audible in only a small volume of space. As a mid-level overview, the present invention presents wearable and/or transportable devices comprising a body, one or more sound generation components, one or more control components, and optionally other components to enhance the functions of the devices.

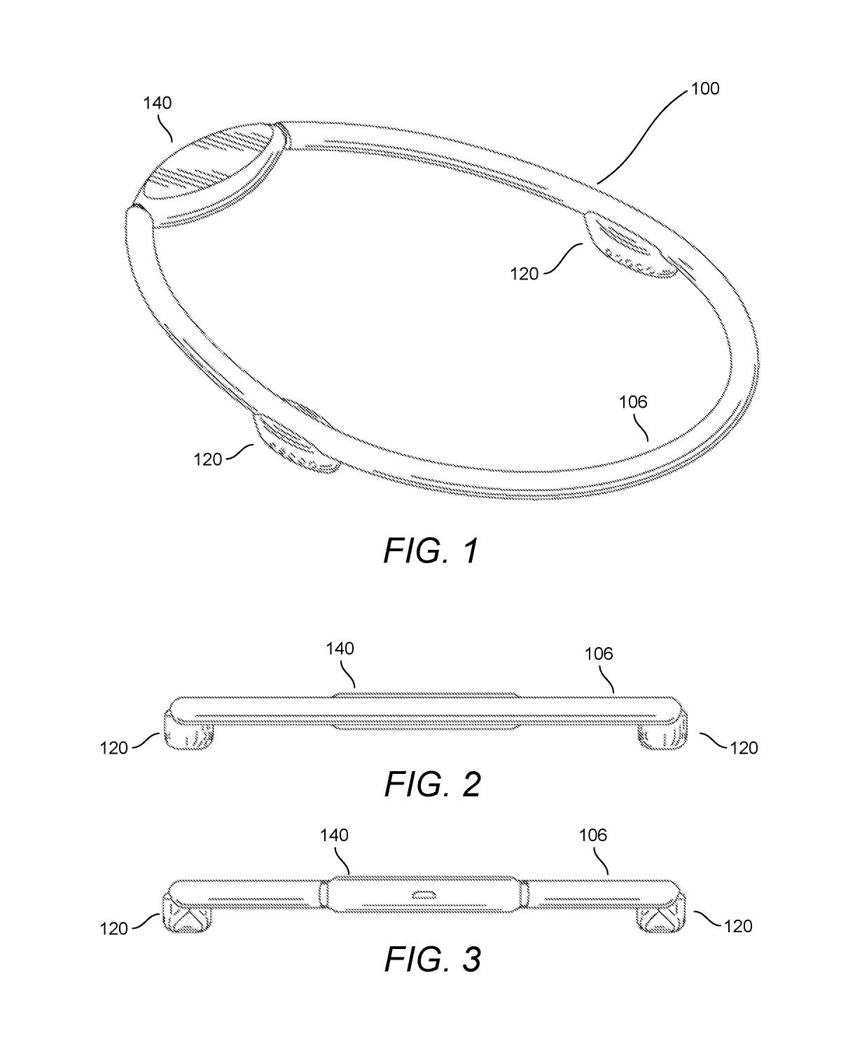

FIG. 1 presents a perspective view of an exemplary wearable acoustical localization device 100, comprising a device body 106, a plurality of sound generation components 120, and a plurality of control components 140. In some embodiments of the present invention, the wearable acoustical localization device 100 may comprise other elements and/or decorative elements, which are not shown here. In this depiction, the device body 106 is configured as a necklace, to be worn about a user's neck, though it will be obvious to one of skill in the art that other embodiments of the present invention are possible (the user is the wearer of the wearable acoustical localization device 100). It has been found advantageous to have one or more of the plurality of sound generation components 120 directed towards the “front” of the device body 106, meaning the side of the device body 106 that is distal to the user's body, such that the plurality of sound generation components 120 would be directed from the device body 106 towards the user's ears or the vicinity of the user's head.

FIG. 2 shows a top elevation of the exemplary embodiment of the present invention, meaning the view of the portion of the device that would sit behind the user's neck, above the user's back. The control component 140 is mostly occluded by the device body 106, and the plurality of sound generation components 120 are visible.

FIG. 3 depicts a bottom elevation of the exemplary embodiment of the present invention, meaning the view of the portion of the device that would sit in front of and below the user's neck, above the user's chest. The control component 140 is visible at the bottom of the device body 106, though one of skill in the art will understand that other embodiments or configurations are possible, and the plurality of sound generation components 120 are visible.

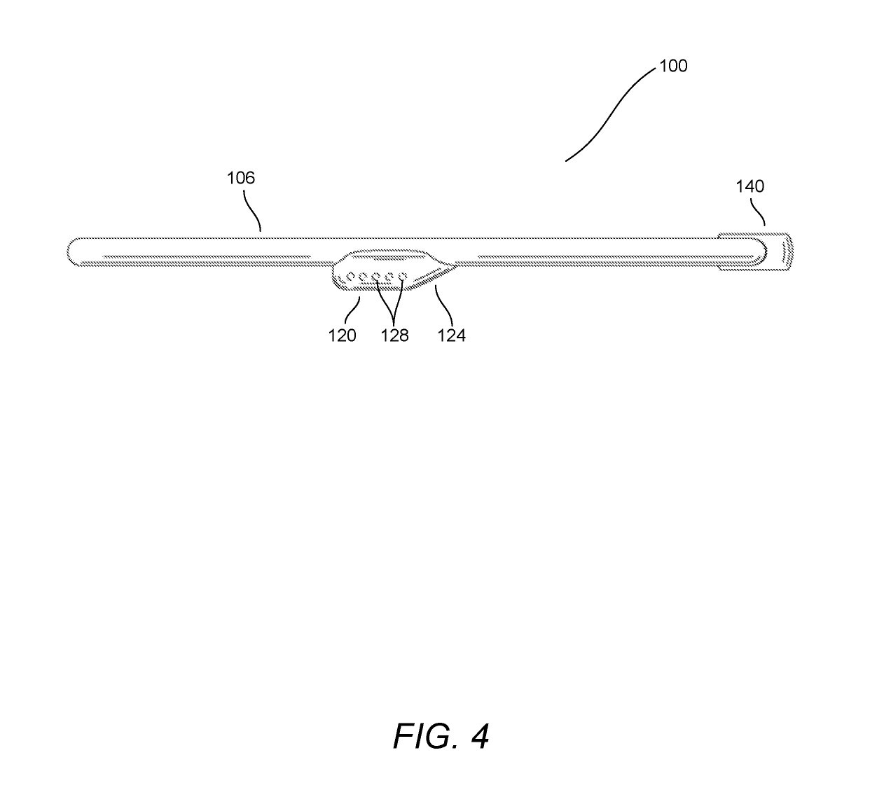

FIG. 4 illustrates a side elevation view of the exemplary wearable acoustical localization device 100 disclosed herein. One of the plurality of sound generation components 120 is visible as attached on the underside of the device body 106, with a haptic element 124 disposed proximal to the user. One or more of the plurality of haptic elements 124 may be configured and/or disposed on the device body 106 to convey touches or vibrations to particular portions of the user's or wearer's anatomy that are conducive to sound or vibration to the vicinity of the user's ear canals. For instance, the haptic element 124 may be configured to vibrate or tap against a user's carotid artery, or against the soft tissue of the neck. In some embodiments of the present invention, one or more of the plurality of haptic elements 124 may be user-configurable, i.e. may be moved by the user within a range of locations on the device body 106, to offer the user an optimizable and customizable acoustical reproduction, that accommodates a user's preferences and can be individualized to each user's dimensions and anatomy. In some embodiments of the present invention, one or more of the plurality of haptic elements 124 may be distinct from the plurality of sound generation components 120. The haptic elements 124 are not necessarily configured on or as part of the plurality of sound generation components 120.

The plurality of acoustic signal egresses 128 on the plurality of sound generation components 120 may, it has been found advantageous, be directed towards the user's ears or vicinity thereof. The plurality of acoustic signal egresses 128 may be orifices in the plurality of sound generation components 120, and may be covered with a thin waterproof material to allow the acoustical signal plane waves 232 to exit the plurality of sound generation components 120 and reach the user while protecting the internal components from water and moisture.

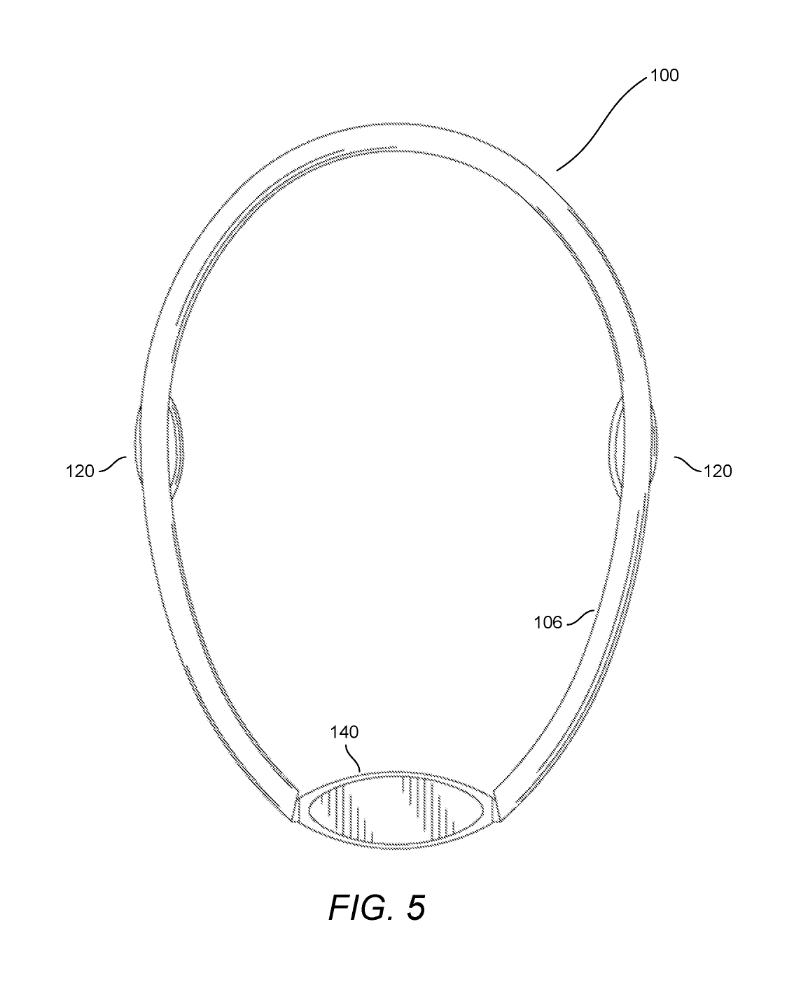

With reference to FIG. 5, a front elevation view of the exemplary embodiment is presented, illustrating the device body 106, the plurality of sound generation components 120 partly occluded by the device body 106, and the control component 140.

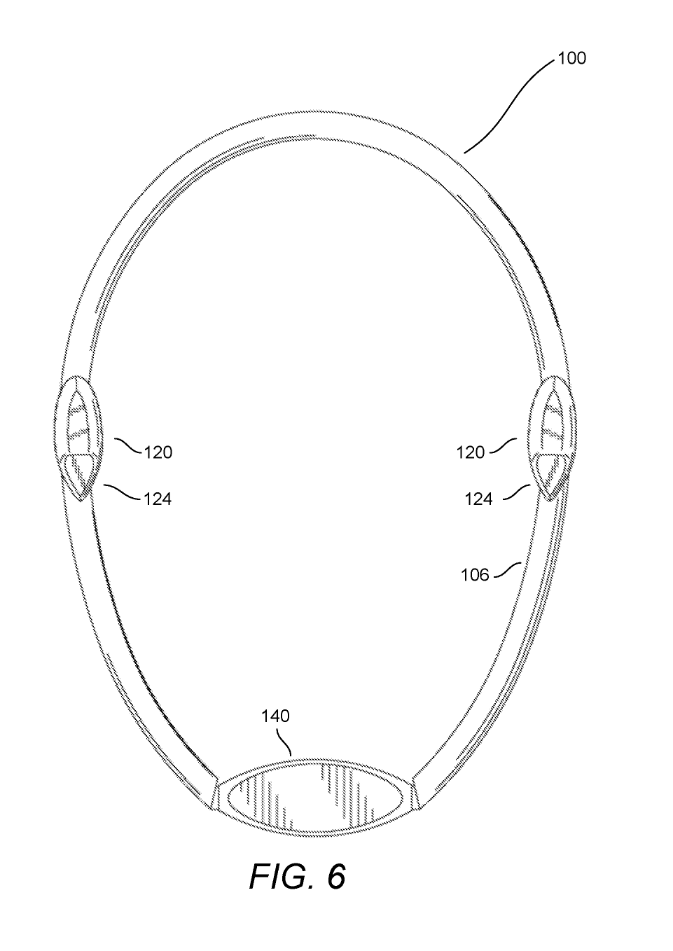

FIG. 6 shows a bottom elevation view of the exemplary embodiment, with the device body 106, the plurality of sound generation components 120 visible, the plurality of haptic elements 124 visible disposed on the sides of the the plurality of sound generation components 120 proximal to the user, and the control component 140 also visible.

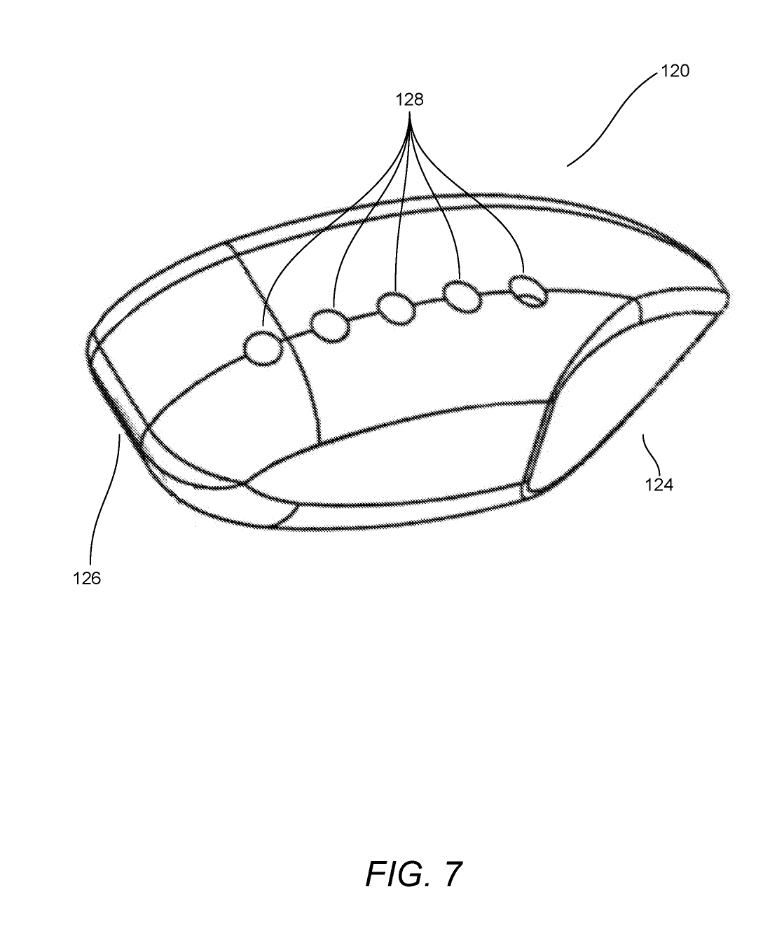

FIG. 7 illustrates a perspective view of one of the plurality of sound generation components 120. Any of the plurality of sound generation components 120 may house a plurality of speakers, which as used herein means any component capable of producing sound, and without limitation may be ultrasonic speakers, audible-range speakers, subsonic speakers, or a combination thereof; for instance, it will be obvious to one of skill in the art that in some embodiments of the present invention may advantageously use speakers capable of producing both ultrasound and audible sound. One or more of the plurality of sound generation components 120 may further comprise one or more of a plurality of haptic elements 124 and/or other sound-producing elements, including but not limited to components that vibrate or tap the user, whether now known or later invented. The plurality of haptic elements 124 may be located inside the plurality of sound generation components 120, or may be partly inside and partly protrude from the plurality of sound generation components 120, or may be disposed on the outside of the plurality of sound generation components 120. The plurality of haptic elements 124 may, it has been found advantageous, be used to transmit the audio information contained in the lower frequencies of the sound being reproduced or generated by the wearable acoustical localization device 100, by use of touch or vibration, as described above. The plurality of ultrasound speakers, audible-frequency speakers, and/or subsonic speakers comprising the plurality of sound generation components 120 may, it has been found advantageous, be used to generate ultrasonic carrier waves and modulate them with audible-frequency sound waves, as will be described below in greater detail.

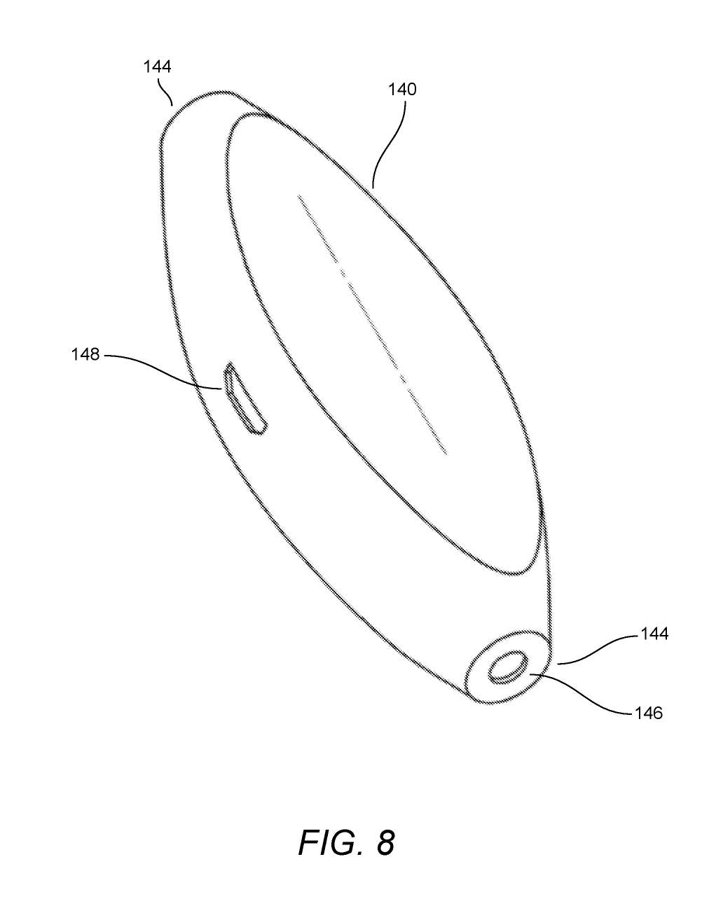

With reference to FIG. 8, illustrating a perspective view of an exemplary control component 140, the externally visible components of the control component 140 are shown, and internal components comprising the control component 140, including but not limited to a plurality of batteries, a plurality of wireless communications modules, a plurality of microphones, and/or a plurality of microprocessors, are not depicted here. The control component 140 comprises a plurality of control attachments 144 that serve to attach the control component 140 to the device body 106. The control component 140 further comprises a plurality of control connections 146, through which control signals, advantageously carried by wires through the device body 106 to the plurality of sound generation components 120, are transmitted by the control component 140 to the plurality of sound generation components 120, such that the plurality of sound generation components 120 may generate acoustical signals. The control component 140 further comprises a charging connector 148, to charge the battery or the plurality of batteries comprising the control component 140. While the charging connector 148 is illustrated here as a shape resembling a micro-USB port, it will be obvious to one of skill in the art that other embodiments of the charging connector 148 are possible, including but not limited to magnetic charging terminals to provide a more waterproof housing for the control component 140.

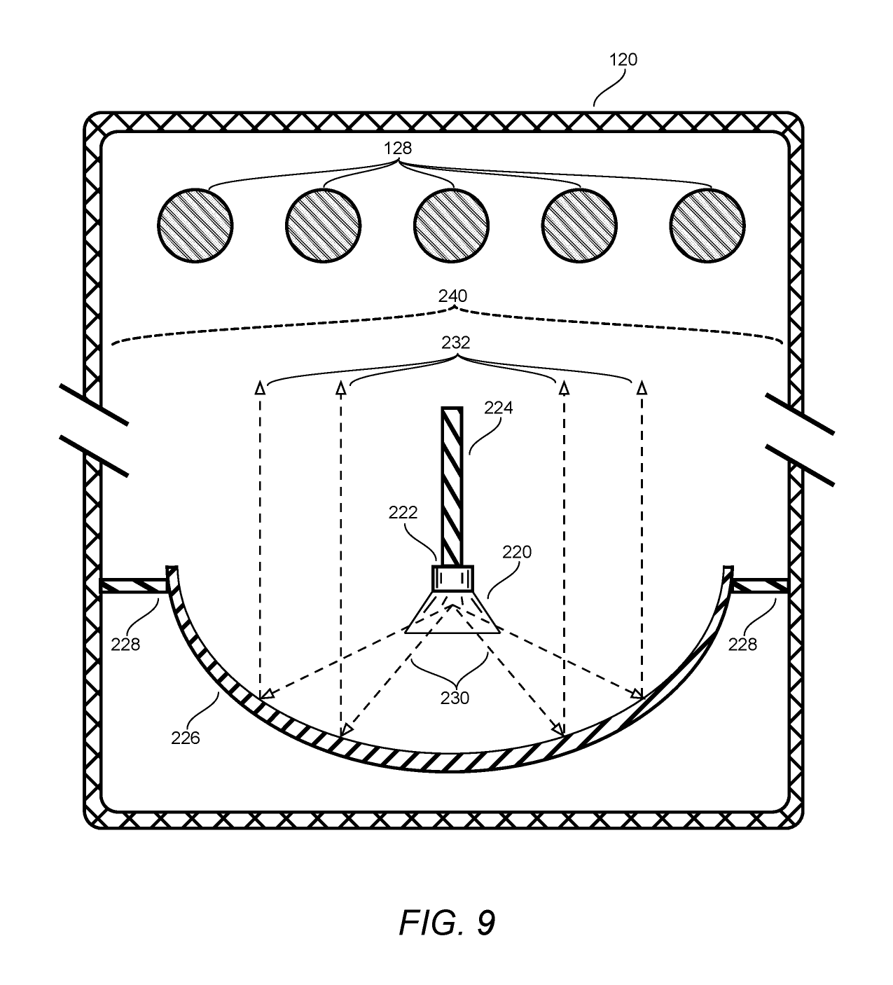

FIG. 9 illustrates a schematic cross-section of an exemplary sound generation component, such as may, in some embodiments of the present invention, be disposed inside of one or more of the plurality of sound generation components 120. The exemplary sound generation component depicted in FIG. 9 is a parabolic speaker, meaning a sound-generating device in which a speaker driver is located at or near the focal point of a parabola, and oriented to direct sound away from the intended audience and towards the center of a parabolic reflector, such that the acoustical signals generated by the speaker driver reflect off of the parabolic reflector and form a beam of plane waves, which can travel farther with less attenuation or dispersal than acoustical signals directed from a speaker directly at the intended audience. Other embodiments of a parabolic speaker are possible, such as one in which multiple speaker drivers are disposed on the surface of a parabolic surface that is directed at the intended audience. It will be obvious to one of skill in the art that, while other embodiments of the present invention are possible, it has been found advantageous to implement the present invention with a single speaker per parabolic surface, given the space and mass constraints of building a wearable acoustical localization device 100.

In the exemplary parabolic speaker 240, disposed inside of one of the plurality of sound generation components 120, a speaker comprising a speaker cone 220 and a speaker driver 222 are supported by a speaker support 224 such that the portion of the speaker driver 222 that interfaces with the speaker cone 220 is located approximately at the focal point of a parabolic reflector 226. The parabolic reflector 226 may be supported by a plurality of reflector supports 228, attached to one of the plurality of sound generation components 120 in which the parabolic speaker 240 is disposed. When the speaker driver 222 generates an emitted acoustical signal 230, the emitted acoustical signal 230 reflects off of the parabolic reflector 226 as acoustical signal plane waves 232 directed at the intended audience: the user's ear or the vicinity of the user's head. It has been found advantageous to have the acoustical signal plane waves 232 be directed at the plurality of acoustic signal egresses 128 in the sound generation component 120, to provide for higher-fidelity acoustical reproduction and greater volume of sound without excessive consumption of power. The plurality of acoustic signal egresses 128 may, it has been found advantageous, be oriented in one or more surfaces of the plurality of sound generation components 120 such that the plurality of acoustic signal egresses 128 are oriented, when the wearable acoustical localization device 100 is worn or carried as that particular embodiment of the wearable acoustical localization device 100 is embodied to be worn or carried, towards the intended volume of space for localized hearing of the produced sound, e.g. towards the user's ears or the vicinity of the user's head.

In some embodiments of the present invention, it may be advantageous to have only one sound generation component 120 per wearable acoustical localization device 100. In other embodiments of the invention, the plurality of sound generation components 120 may be disposed with one per side of the device body 106, as are depicted in various of the figures. It will be obvious to one of skill in the art that other embodiments of the present invention are possible, including embodiments with more than one sound generation component 120 per side of the device body 106. In some embodiments of the present invention, there may be disposed only one sound-generating element per sound generation component 120, which may be a parabolic speaker 240, a haptic element 124, or other acoustical signal generation means now known or later invented. In other embodiments of the present invention, it may be advantageous to dispose more than one sound-generating element per sound generation component 120.

In embodiments with a plurality of parabolic speakers 240 per wearable acoustical localization device 100, whether the plurality of parabolic speakers 240 are disposed in one of the plurality of sound generation components 120 or in more than one of the plurality of sound generation components 120, it has been found advantageous to locate the parabolic speakers 240 at some distance apart from each other on the wearable acoustical localization device 100, and to separately control, with the control component 140, the acoustical signals produced by each of the plurality of parabolic speakers 240, such that a first plurality of acoustical signal plane waves 232 produced by a first parabolic speaker 240 interfere with at least a second plurality of acoustical signal plane waves 232 produced by at least a second parabolic speaker 240, with the phases and amplitudes of the first plurality of acoustical signal plane waves 232 interfering with the phases and amplitudes of the second plurality of acoustical signal plane waves 232. It has been found advantageous to have the first plurality of acoustical signal plane waves 232 and the second plurality of acoustical signal plane waves 232 constructively interfere with each other in the intended volume or region of space for listening to the audio information (i.e., near the user's ears or in the vicinity of the user's head) and destructively interfere with each other in other volumes or regions of space. It will be obvious to one of skill in the art that some embodiments of the present invention may include more than two such parabolic speakers 240 per wearable acoustical localization device 100, including but not limited to embodiments with two or more such parabolic speakers 240 per side of the device body 106 of the wearable acoustical localization device 100. Such embodiments may also be implemented with speakers that are not parabolic speakers 240.

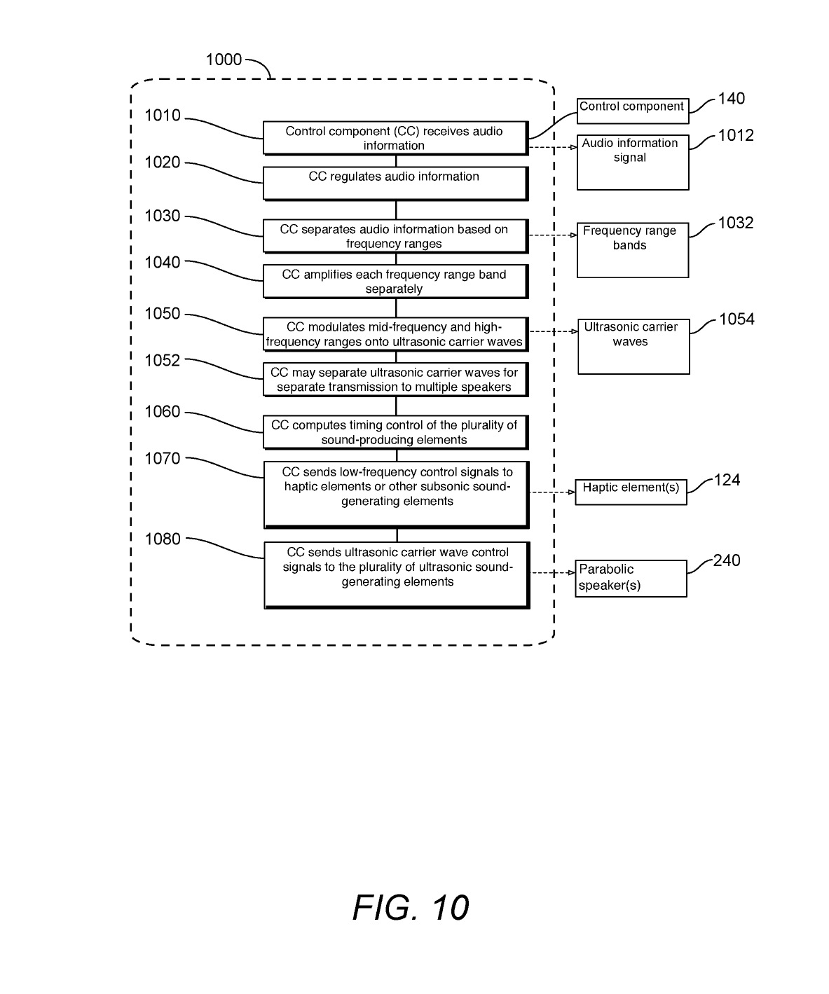

With reference to FIG. 10, an exemplary method of processing audio information for transmission to a plurality of sound generation components 120 is presented. In the exemplary method 1000 of processing audio information, the control component 140 receives 1010 a plurality of audio information signals 1012, which reception may be wired or wireless, and may be from a mobile device (a cellular telephone, a smartphone, a tablet or phablet, or other mobile device now known or later invented), a laptop or desktop computer, or other source of audio information signals 1012. The audio information signals 1012 may be music, or voice communications, or other signals encoding other audio information. The control component 140 regulates 1020 the audio information signals 1012; said regulating 1020 may comprise controlling the output levels, conditioning the audio information signals 1012 to remove noise or static, or otherwise processing or modifying the received audio information signals 1012. The control component 140 separates 1030 the audio information signals 1012 based on frequency ranges. Said frequency ranges may be predefined or may be determined dynamically based on the frequencies present in the audio information signals 1012, but it has been found advantageous to have lower frequencies, mid-range frequencies, and higher frequencies separated into a plurality of separate frequency range bands 1032. Thereafter, the control component 140 amplifies 1040 each of the plurality of frequency range bands 1032 separately.

It has been found advantageous to have the control component 140 modulate 1050 mid-frequency and high-frequency bands, from the plurality of frequency range bands 1032, onto ultrasonic carrier waves 1054. In some embodiments of the present invention, the control component 140 may separate 1052 one or more of the ultrasonic carrier waves 1054 for separate transmission to one or more of the plurality of ultrasonic speakers, which may include parabolic speakers 240. As described above, with multiple parabolic speakers 240, it is possible to use multiple ultrasonic carrier waves 1054 and constructive interference to create audible sound in particular regions of space while making the ultrasonic carrier waves 1054 inaudible to listeners or listening devices, e.g. microphones, in locations other than the intended listening location. The control component 140 then computes the timing control 1060 of the ultrasonic carrier waves 1054 to be sent to particular ultrasonic sound-generating elements, e.g. parabolic speakers 240 or other speakers, based on the particular design (e.g., the relative size, shape, and location of the plurality of sound generation components 120) of the wearable acoustical localization device 100, and computes the timing control 1060 of a plurality of subsonic elements, e.g. the other plurality of sound-generating elements of the plurality of sound generation components 120, e.g. the plurality of haptic elements 124, such that the ultrasonic carrier waves 1054 may arrive in the intended listening region to generate audible sound from the acoustical signal plane waves 232 at the same time, or approximately the same time, that the audio signals from the low-frequency range bands 1032 can arrive, from the plurality of haptic elements 124, at the listener's ears or ear canals, and that the plurality of ultrasonic carrier waves 1054 may arrive properly timed to generate audible acoustical signals through constructive interference in the intended volume of space for listening.

The control component 140 then sends 1070 low-frequency control signals, via the plurality of control connections 146, to a plurality of subsonic or vibration-producing elements, including but not limited to the plurality of haptic elements 124. The control component 140 also sends 1080 ultrasonic carrier wave control signals, via the plurality of control connections 146, to the plurality of ultrasonic sound-generating elements, including but not limited to the plurality of parabolic speakers 240, or other ultrasound generating elements.

Certain embodiments of the present invention were described above, to provide methods for brewing beer or other malt beverages with altered electrolyte levels and/or altered flavor profiles. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, I claim:

1. A wearable acoustical localization device, the device comprising:
a device body;
a plurality of sound generation components disposed on the device body,
which house a plurality of speakers; and
a plurality of control components.

2. The wearable acoustical localization device of claim 1, in which one or more of the plurality of sound generation components is directed towards the vicinity of the user's head.

3. The wearable acoustical localization device of claim 1, in which the device further comprises a plurality of haptic elements.

4. The wearable acoustical localization device of claim 3, in which one or more of the plurality of haptic elements are disposed on the device body to convey touches or vibrations to particular portions of the user's anatomy.

5. The wearable acoustical localization device of claim 3, in which one or more of the plurality of haptic elements are user-configurable.

6. The wearable acoustical localization device of claim 3, in which one or more of the plurality of haptic elements are configured as part of one or more of the plurality of sound generation components.

7. The wearable acoustical localization device of claim 1, in which one or more of the plurality of sound generation components further comprises a plurality of acoustic signal egresses.

8. The wearable acoustical localization device of claim 3, in which the plurality of haptic elements are used to transmit the audio information contained in the lower frequencies of the sound being reproduced or generated by the device.

9. The wearable acoustical localization device of claim 1, in which one or more of the speakers are ultrasound speakers.

10. The wearable acoustical localization device of claim 1, in which one or more of the speakers are parabolic speakers, which parabolic speakers further comprise a speaker driver located approximately at the focal point of a parabolic reflector.

11. The wearable acoustical localization device of claim 10, in which the parabolic speakers are located at some distance apart from each other on the device.

12. The wearable acoustical localization device of claim 1, in which at least one of the plurality of control components further comprises:
a plurality of batteries,
a plurality of wireless communications modules,
a plurality of microphones,
a plurality of microprocessors,
a plurality of control attachments,
a plurality of control connections, and
a charging connector.

13. A method of processing audio information for transmission to a plurality of sound generation components, the method comprising the steps of:
receiving a plurality of audio information signals;
regulating the audio information signals;
separating the audio information signals into a plurality of frequency range bands based on frequency ranges;
amplifying each of the plurality of frequency range bands separately;
sending low-frequency control signals to a plurality of subsonic elements; and
sending ultrasonic carrier wave control signals to a plurality of ultrasonic sound-generating elements.

14. The method of claim 13, in which, after separating the audio information signals into a plurality of frequency range bands, the method further comprises modulating mid-frequency and high-frequency bands, from the plurality of frequency range bands, onto ultrasonic carrier waves.

15. The method of claim 14, the method further comprising the step of separating one or more of the ultrasonic carrier waves for separate transmission to one or more of the plurality of ultrasonic sound-generating elements.

16. The method of claim 15, the method further comprising using multiple ultrasonic carrier waves and constructive interference to create audible sound in particular regions of space.

17. The method of claim 13, in which the method further comprises computing the timing control of the ultrasonic carrier waves to be sent to particular ultrasonic sound-generating elements, and computing the timing control of the plurality of subsonic elements.

18. The method of claim 13, in which the plurality of subsonic elements further comprise a plurality of haptic elements.

19. The method of claim 13, in which the plurality of ultrasonic sound-generating elements further comprise a plurality of parabolic speakers.

20. A portable acoustical localization device for producing a full range of human-audible sound from inputs of a plurality of audio information, the device comprising:
a plurality of parabolic speakers capable of producing ultrasound; and
a plurality of haptic elements;
in which the plurality of parabolic speakers are configurable to reproduce audible mid-range and high-frequency sound from the plurality of audio information, and to localize such sound in a particular region of space; and
the plurality of haptic elements are configurable to reproduce audible low-frequency sound from the plurality of audio information, by transmitting to a user a plurality of touch sensations.
